(19) United States
(12) Patent Application Publication
(10) Pub. No.: US 2024/0289684 A1
(43) Pub. Date: Aug. 29, 2024

(54) LAYER-WISE EFFICIENT UNIT TESTING IN VERY LARGE MACHINE LEARNING MODELS

(71) Applicant: Dell Products L.P., Round Rock, TX (US)

(72) Inventors: Paulo Abelha Ferreira, Rio de Janeiro (BR); Vinicius Michel Gottin, Rio de Janeiro (BR); Pablo Nascimento da Silva, Niterói (BR)

(21) Appl. No.: 18/175,681

(22) Filed: Feb. 28, 2023

(51) Int. Cl. G06N 20/00

(52) U.S. Cl. CPC G06N 20/00

(57) ABSTRACT

Generating compressed models for unit testing from very large machine models is disclosed. A framework is provided that allows compressed models to be generated that include selectively compressed layers. This allows the impact of changes to a codebase be evaluated using compressed models in a layer specific manner.

### RELATED APPLICATIONS

This application is related to U.S. Ser. No. 17/646,015 filed Dec. 27, 2021, which application is incorporated by reference in its entirety.

### FIELD OF THE INVENTION

Embodiments of the present invention generally relate to machine learning models and to testing machine learning models, including very large machine learning models. More particularly, at least some embodiments of the invention relate to systems, hardware, software, computer-readable media, and methods for testing very large machine learning models and to testing layers of very large machine learning models.

### BACKGROUND

Machine learning models are examples of applications that are able to perform various tasks, such as generating inferences, without being specifically programmed to generate the inferences. Rather, machine learning models are trained with data such that, when presented with new data, an inference can be generated. There are different manners in which machine learning models learn. Examples of learning include supervised learning, unsupervised learning, semi-supervised learning and reinforcement learning.

Generally, a machine learning model is trained with certain types of data. The data may depend on the application. Once trained or once the machine learning model has learned from the training data, the machine learning model is prepared to generate predictions or inferences using real data.

Training a machine learning model, however, can be costly. This is particularly true for certain machine learning models such as VLMs (Very Large Models). VLMs may have, for example, a very large number of parameters. As a result, training and testing VLMs can be costly from both economic and time perspectives.

The training and testing difficulties associated with VLMs can present problems whenever a change is made to anything associated with the operation of the VLM. If a change is made to the dataset, the model pipeline, or the codebase, there is a need to ensure that the VLM remains valid. In fact, there are many instances where it is critical to have quality and performance guarantees, such as in self-driving vehicles. Accordingly, example embodiments disclosed herein address issues associated with retraining and retesting VLMs while minimizing costs and ensuring that changes surrounding the VLMs do not adversely impact the behavior of the VLMs.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of automatic or semi-automatic unit testing of very large machine learning models;

FIG. 2A discloses aspects of testing very large machine learning models;

FIG. 2B discloses additional aspect of testing very large machine learning models using compressed models;

FIG. 3 discloses aspects of automatic or semi-automatic testing of specific layers of very large machine learning models;

FIG. 4A discloses aspects of generating compressed models that include selectively compressed layers;

FIG. 4B discloses aspects of a compressed model;

FIG. 5A discloses aspects of compressing a machine learning model;

FIG. 5B illustrates aspects of a compressed model;

FIG. 6 discloses aspects of layer-wise compression; and

FIG. 7 discloses aspects of a computing device, system, or entity.

### DETAILED DESCRIPTION OF SOME EXAMPLE EMBODIMENTS

Embodiments of the present invention generally relate to machine learning models including very large machine learning models (VLMs), referred to generally herein as models. More particularly, at least some embodiments of the invention relate to systems, hardware, software, computer-readable media, and methods for unit testing of very large machine learning models.

Model management relates to managing models and ensures that the models meet expectations and business requirements. Model management also ensures that models are properly stored, retrieved, delivered in an up-to-date state, and the like. Embodiments of the invention relate to increasing quality assurance when a change or changes are made to a model pipeline, model datasets, model codebase, or the like. Embodiments of the invention are able to retrain and/or retest a model while reducing or minimizing costs.

Retraining and/or retesting models such as VLMs can be cost prohibitive and embodiments of the invention ensure that, when a change that may impact the behavior of a model occurs, the training and validation behavior remains the same or sufficiently close to the expected behaviors of the model prior to the change. In order to retrain and/or retest in a more cost-effective manner, embodiments of the invention may generate a small or proxy version of a model using compression, such as neural network compression. Embodiments of the invention may perform unit testing on compressed models.

More specifically, embodiments of the invention relate to a framework that allows specific tests to be performed to test specific functionality of the VLM. The framework allows specific tests to be created for a given functionality of a model such as a VLM. These tests, however, are performed using the compressed or proxy versions of the VLMs.

Embodiments of the invention further relate compressed models in which specific layers of the VLM are compressed. These models are distinct from compressed models in which the entire VLM is compressed. By compressing specific or selected layers of the VLM, unit testing can focus on testing specific layers or specific subsets of layers of a VLM.

For example, a test for the expected final training error or the expected validation error curve may be created. These tests are executed using the proxy or compressed versions of the models.

Aspects (e.g., functionality, behavior, metrics) of models can be tested using unit tests. A unit test, which may be automated, helps ensure that a particular unit of code or other aspect of a model is performing the desired behavior. The unit of code being tested may be a small module of code or relate to a single function or procedure. In some examples, unit tests may be written in advance.

Model compression allows a compact version of a model to be generated. Compression is often achieved by decreasing the resolution of a model's weights or by pruning parameters. Embodiments of the invention ensure that the compressed model achieves similar performance on selected metrics with respect to the original uncompressed model. The compressed models may be, by way of example only, 10%-20% of the size of the original models while still achieving comparable metrics.

Embodiments of the invention more specifically relate to testing specific subsets of layers of a VLM automatically and efficiently.

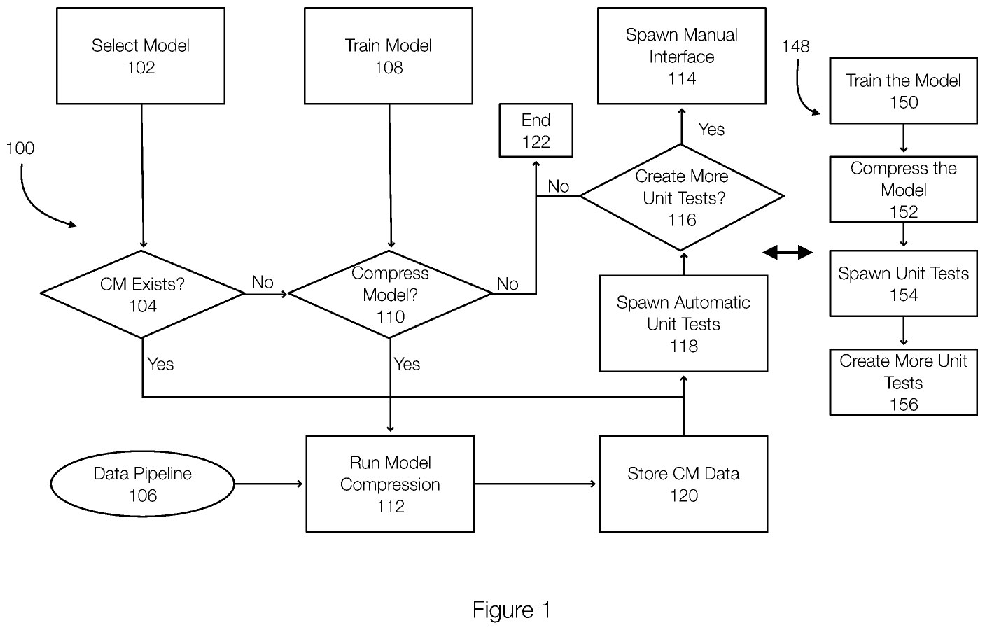

FIG. 1 discloses aspects of a framework for managing models and/or unit testing. FIG. 1 presents a method 100 performed in a framework that allows models to be tested more effectively. The framework generally executes unit tests on compressed models (CMs), which are generated by compressing the corresponding models. The CMs are examples of proxy versions of the original VLMs. Embodiments of the invention are capable of testing multiple models independently and simultaneously using corresponding compressed models.

The method 100 may begin in different manners. For example, the method 100 may begin by selecting 102 a model that has already been trained. If a compressed model (CM) for the selected model exists (Yes at 104), the method may spawn 118 automatic unit tests. Spawning tests 118 may include recommending tests for execution. These tests may have been developed in advance and may be automatically associated with the CM.

If the CM does not exist (No at 104), the model may be compressed 110. If the model is not compressed, the method ends 122. If a compressed model is generated (Yes at 110), the compressed model is run or executed 112 using a data pipeline 106. Metadata generated from running the compressed model is stored 120 and unit tests may be created or spawned 118.

Another starting point is to train 108 a model and then compress (Yes at 110) the model. If the model is not compressed, (No at 110), the method may end 122. If there is a need to compress 110 the model that has been trained 108 (Yes at 110), the model is compressed and a compressed model is run 112 based on data from a data pipeline 106. The output of the compression model is stored 120 as CM metadata and automatic unit tests are spawned 118.

Training 108 a model, particularly a very large model, may require access to large amounts of storage and multiple processors or accelerators. Training the model may require days or weeks, depending on the resources. Because of the time required to train the model or for other reasons, embodiments of the invention may store metadata associated with training the model. The metadata generated and/or stored may include, but is not limited to, training/validation loss evolution, edge cases with bad prediction, timestamps for waypoints along training/validation, or the like. These metadata can be used for various automatic unit tests. More specifically, the unit test may generate or be associated with metadata that can be compared to the metadata generated during training.

As previously stated, compressing a model into a CM is performed and metadata associated with training and validating the CM are stored. Embodiments of the invention do not require the CM to achieve the same level of accuracy or other metric as the original model. Rather, the CM serves as a valid proxy when the metric or other output is reasonable. Reasonable may be defined by a threshold value or percentage. Further the assessment of the metric or output can be based on hard (exact) or soft (withing a threshold deviation) standards.

Embodiments of the invention may rely on the relationship between the metadata gathered or generated by the CM and the metadata gathered or generated by the original model. When running a unit test, the current training or validation data or metrics (metadata) generated by the running or executing the CM with the change may be compared to the metadata stored in association with the model prior to the change. This allows the impact of the change on the uncompressed model to be determined or estimated.

Regardless of the starting point of the method 100 (selecting 102 or training 108 a model), once a CM is associated with a model and metadata for the CM has been generated, a series of automatic unit tests can be created or spawned 118. These unit tests may assert a hard or soft comparison between the metadata of the stored CM with the metadata of the CM based on the modified code base.

In addition, embodiments of the invention allow a user to create 116 additional unit tests, for example via a manual interface 114. These unit tests can be based on any metadata related to the CMs and may be created to address cases or situations that are not covered by the automatically generated unit tests.

In general, the method 100 may be represented more compactly by the method 148 performed in a framework 100. The method 148 may include training/selecting 150 a model. When training a model, particularly for VLMs, a large amount of resources is required. As previously stated, training a VLM may take days or weeks, depending on the available resources. Because this is expensive, in terms of time and cost, embodiments of the invention store metadata associated with training and/or operation of the trained model. The metadata may include, by way of example, training/validation loss evolution, edge cases with bad prediction, timestamps for waypoints along training/validation, or the like. These metadata are useful for a suite of automatic unit tests based on comparing such metadata with the metadata gathered by the training/validating a compressed model.

The trained/selected model is compressed 152 to generate a compressed model. In one example, the trained/selected model may already be associated with a compressed model and the compressed model does not need to be generated. A VLM may be compressed using various techniques into a compressed model (CM). Embodiments of the invention perform the compression (e.g., once if possible) and store all of the metadata associated with training and validating the CM. The CM is not required to achieve the same level of accuracy (or other metric) as the VLM. However, the CM should achieve a level of accuracy such that the CM can serve as a proxy. Determining whether the CM is sufficiently accurate may be judged by an expert. In addition, embodiments of the invention also focus on the relationships between the metadata gathered by the CM and the metadata gathered by the VLM. This ensures that, when running a unit test, the training or validation data or metrics generated for the CM in light of the change to the data pipeline or codebase can be evaluated in light of or compared with the metadata for the CM previously stored and/or the metadata of the original VLM.

Unit tests can be created or spawned 154 for the compressed model. Additional unit tests can be created 156 for the compressed model. Once a CM is created, validated, and associated with a VLM, a series of unit tests that aim at asserting a soft or hard comparison between one or more metadata associated with the stored CM and a current run of the CM on a modified codebase can be created.

In addition, more unit tests can be created 156. In some examples, the framework may be used to create additional units tests that may relate to cases or situations not covered by automatically generated unit tests. The user is allowed to use any metadata from the given CM to create a unit test that can compare one or multiple metrics derived from the model and/or metadata. Due to potentially high computational demands, a developer may be able to turn unit tests on/off.

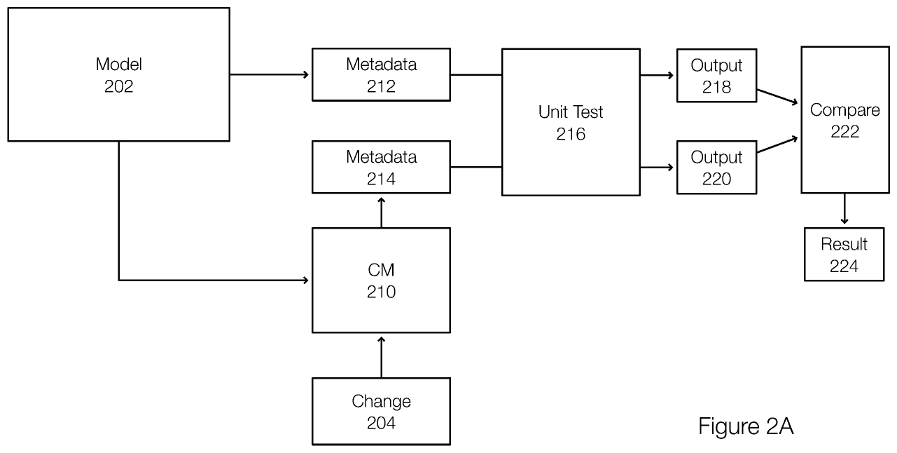

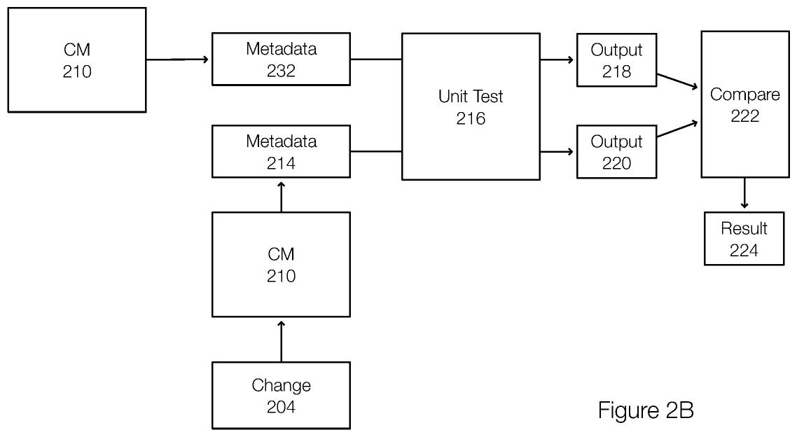

FIG. 2A discloses aspects of unit tests and unit testing. Unit tests can vary widely in function and purpose and the following discussion provides a few examples. Embodiments of the invention are not limited to these examples. FIG. 2A illustrates a model 202. The CM 210 is generated by compressing model 202. Metadata 212 is generated from operation and/or training of the model 202.

Whenever there is a change that impacts the model 202, it may be necessary to determine whether the behavior or other aspect of the model 202 is affected. In this example, the model 202 may be impacted by or associated with a change 204. The change 204 may be a change to the training data or other data set, the codebase of or used by the model 202, the pipeline or the like. The metadata 214 is generated from operation of the CM 210.

The unit test 216 can be performed separately or independently on the metadata 212 and the metadata 214. Thus, the unit test 216 generates an output 218 from the metadata 212 and the unit test 216 generates an output 220 from the metadata 214. The output 218 and 220 are compared 222 to generate a result 224. The result 224 may indicate whether the model 202 is operating as expected or whether any change in behavior is acceptable in light of the change 204. Stated differently, the result 224 may indicate that the behavior, prediction, or other aspect of the model 202 is operating properly or valid for the aspect of the model 202 tested by the unit test 216.

As illustrated in FIG. 2A, the impact of the change 204 on the model 202 is evaluated by generating the metadata 214 using the CM 210 in the context of the change 204. In other words, the CM 210 runs and the metadata 214 reflects the change 204, which may be to the training data or other data set, codebase, or model pipeline.

Embodiments of the invention allow the behavior of the model 202 to be evaluated based on unit tests that are applied to the CM 210. More specifically, the behavior of the model 202 can be compared to the behavior of the CM 210. The behavior of the CM 210, which is operated in the context of the change 204, allows the impact of the change 204 on the model 202 to be determined and to determine whether the behavior of the model 202 will be acceptable in light of the change 204.

As previously stated, unit tests may be generated automatically. Once a CM is generated, unit tests can be automatically associated with the CM. This is one way to identify which unit tests should be performed in the event of the change 204. Further, unit tests can be suggested (e.g., based on actions of other users or based on unit tests for similar models) to the user. Unit tests may also be created.

Unit tests can be created to test different functions, metrics, or other aspects of models and may be specific to changes or to the type of the change. Thus, changes impacting the codebase may be performed with specific metadata or metrics related to the part of the codebase that was changed. Unit testing is often used in test-driven machine learning development. This allows tests to be written in order to detect changes to intended behavior. This allows for development to be performed rapidly.

In the context of very large machine models, automatic unit testing using CMs overcomes the problem of having to test the actual model. Unit tests can be generated based on generic algorithms, based on feedback, or the like.

For example, the unit test 216 may be an inner model metric unit test. In this case, the unit test attempts to measure deviation from established inner model metrics. For a given dataset (or portion thereof), for example, a certain final state or behavior may be expected. The metric can involve a single hidden layer, two or more hidden layers, interactions between those layers, or the like.

When the output 220 (for the CM 210 with the change 204) is sufficiently close or equal to the output 218 (for the model 202 without the change), then the test may be a success. More specifically, the unit test is performed on metadata 214 generated by the compressed model 210 rather than the model 202 itself because, as previously stated, testing very large machine models takes substantial time and/or cost. Thus, the output 220 is associated with the compressed model 210 and gives an indication of how the change 204 impacted the original model 202.

If the deviation (e.g., difference between the output 220 and the output 218) is sufficiently small or within a threshold (e.g., 1%, 2%, 3%, 4%, 5%, 6%, 7%, 8%, 9%, 10%, or other value), the test may be a success. In this example, the metadata associated with an inner model metric unit test may include values pertaining to hidden layers of the model/CMs in relation to a given dataset or portion thereof. These metadata serve to assert the expected behavior of the model with respect to a given set of input samples and allow the functionality of the model 202 to be tested using the CM 210 that is operated in the context of the change 204.

In another example, the unit test 216 may be an output metric unit test. Output metric unit tests are configured to compare the output 218 (e.g., a prediction or inference) associated with the model 202 with the output 220 associated with the CM 210. The output metric unit test is thus configured to determine the impact of a change to the codebase (e.g., data processing, pipeline code changes). In this example, the changes to the codebase do not affect the input entering the CM 210. If the CM is deterministic, then the outputs 218 and 220 can be compared. More specifically, the output metric unit test may perform a soft comparison as changes to the dataset or output may be expected. In one example, only minor changes are expected. Thus, a threshold between the outputs 218 and 220 can be determined. In this example, the metadata 212 and 214 may include values output by the CM with respect to a given dataset or set of datasets thereof. If a soft comparison is performed, the unit test may be successful if the deviation or difference is within a threshold or is acceptable to a user.

The unit test 216 may be an evolution metric unit test. This type of unit test is configured to compare the evolution of a given metric across an interval of time or steps, such as the validation loss curve. The metadata may include values related to the evolution of one or more metrics across time, such as for training, validation, or the like.

The change 204 may include changes to the model pipeline, datasets, or codebase. For example, datasets used in machine models undergo processing. The change 204 may be related to data ETL (Extract-Transform-Load). This is a process of moving and transforming data from an environment where the data is stored to a volume where it can be used, such as by a machine learning model. This may include feature extraction, parameter related processing, or the like. Any modification to the ETL process (e.g., the change 204) may affect the behavior of the model 202. As a result, unit tests may be created to determine whether changes to the ETL in the context of the CMs have affected the behavior of the original model. Thus, the impact of the ETL changes on the model 202 can be determined based on the output 220 using the metadata 214 of the CM 210.

The change 204 may relate to library updates or rollbacks. When there is a modification to a library used to process or model a codebase (e.g., Machine Learning framework libraries), it is useful to test for the expected behavior of the model based on how these changes relate to how the model is trained, runs, or is stored.

The change 204 may relate to hardware changes. Modifications to the hardware (e.g., CPU (Central Processing Unit)/GPU (Graphical Processing Unit) version) running the model May impact the behavior of the model. It may be useful to ensure that these changes do not change or only minimally change (within a threshold) the expected behavior.

As previously suggested unit tests can be performed to ensure that expected behavior does not change or that the behaviors do not deviate from expected behavior by more than a threshold. Embodiments of the invention integrate model compression and unit testing in the same framework.

FIG. 2B discloses additional aspects of testing very large machine learning models using compressed models. FIG. 2B illustrates metadata 232 that is generated by the CM 210 prior to the change 204. This allows the operation of the very large machine learning model to be tested by comparing the metadata 232 generated by the CM 210 with the metadata 214 that is generated by the CM 210 in light of the change 204.

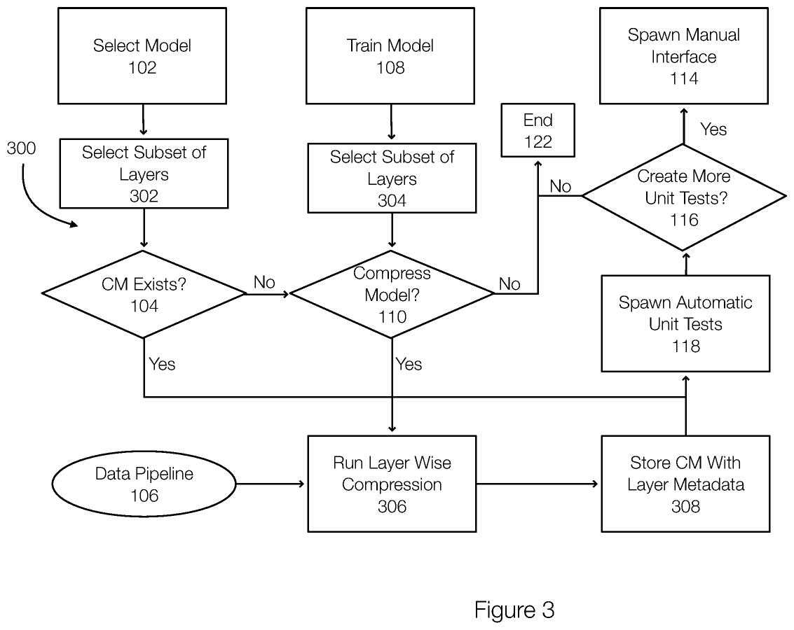

FIG. 3 discloses aspects of automatic or semi-automatic testing of specific layers of very large machine learning models. FIG. 3 is similar to FIG. 1 and elements with the same reference numerals are the same or similar. Thus, the method 300 includes some of the functionality of the method 100.

The method 300 relates to compressed models that include selectively compressed layers. While the compressed model in the method 100 is fully compressed, the compressed models in FIG. 3 are partially compressed. In the method 300, after selecting 102 a model, a subset of layers 302 is selected. If a compressed model exists 104 (Y at 104), then automatic unit tests may be spawned 118 and performed as previously described.

Similarly, if a model is trained 108, a subset of layers may be selected 304 after the model is trained and/or validated. If the compressed model is then generated by selectively compressing layers (Y at 110), layer wise compression 306 is performed for the data pipeline 106. The compressed model is then stored 308 with layer specific metadata and/or model specific metadata. The method 300 allows compressed models to be created that are, in effect, partially compressed VLMs rather than fully compressed VLMs.

Partially compressed models provide value by providing the ability to inspect and test specific layers in the models. Benefits are recognized in auto-labeling, drift detection, explainability, and transfer learning. Partially compressed models also provide the ability to test alternative implementations of specific layers of VLMs because it facilitates fast prototyping and development.

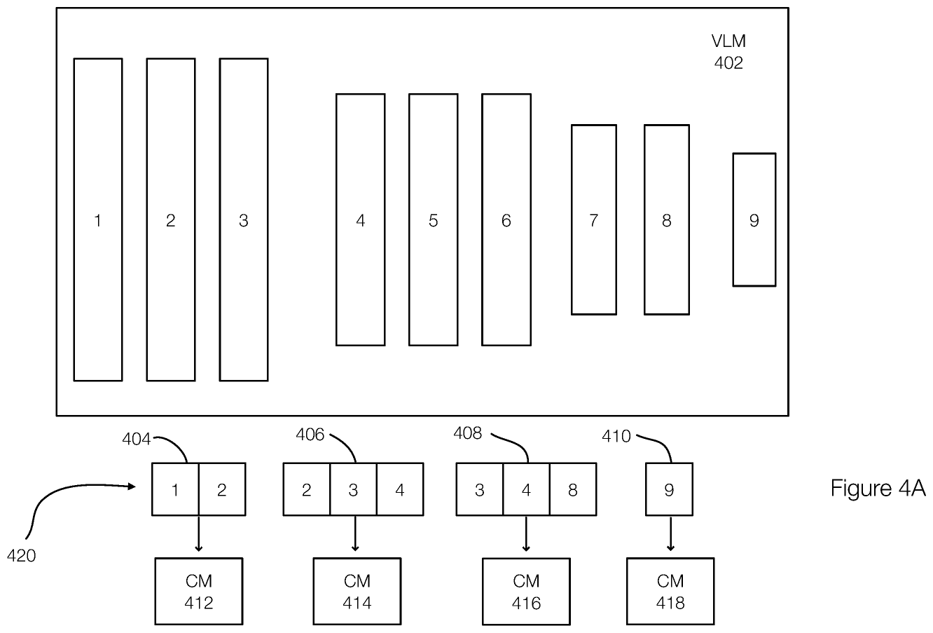

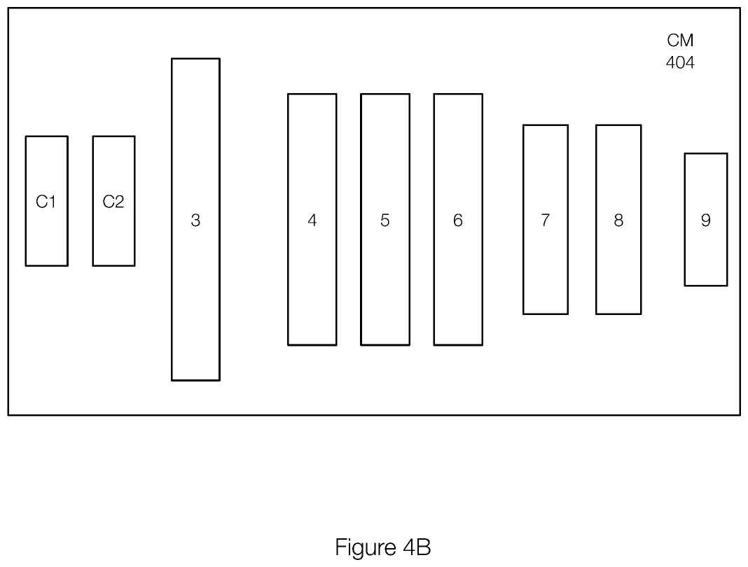

FIG. 4A discloses aspects of generating compressed models. More specifically, FIG. 4A discloses aspects of generating compressed models with selectively compressed layers. FIG. 4A illustrates a VLM 402 that includes, for illustrative purposes, 9 layers (layers 1-9). Layers 1-9 may represent many layers and represent various types of layers. Layers 1-3, for example, may be feature extraction layers. Layers 4-6 may represent embedding layers. Layers 7-8 may represent convergence layers. Layer 9 may represent an output layer.

FIG. 4A also illustrates an example of layer selection 420. In this example, four different layer selections 404, 406, 408, and 410 have been performed. The layer selection 404 includes layers 1-2 of the VLM 402. Once the layer selection 404 is performed, the VLM 402 is compressed to generate the compressed model (CM) 412. Similarly, the selected layers 406, 408, and 410 are identified in the process of generating, respectively, CMs 406, 408, and 410. In one example, compressed layers may be stored and used later. Thus, if the layer selection 404 is performed first and the CM 412 is generated, the compressed layer 2 may be stored and used when compressing the model 402 using the selected layers 406 to generate the CM 414.

FIG. 4B discloses aspects of a compressed model. More specifically, FIG. 4B illustrates the compressed model 404 from FIG. 4A in more detail. The compressed model 404, rather than including layers 1-2, includes compressed layers C1-C2. In this example, layers 3-9 of the compressed model 404 are unchanged compared to the VLM 402. The size of the compressed layers C1-C2 may vary depending on the amount of compression, the size of the original layers, or the like.

The layers that are selected from a particular VLM for compression can vary. The layers that are selected for compression may be selected based on model or layer characteristics, model class, testing requirements, model architecture, or the like. Compressed models can also be generated in advance. As illustrated in FIG. 3, the compressed model may already exist (Y at 104) when there is a need or desire to perform unit testing.

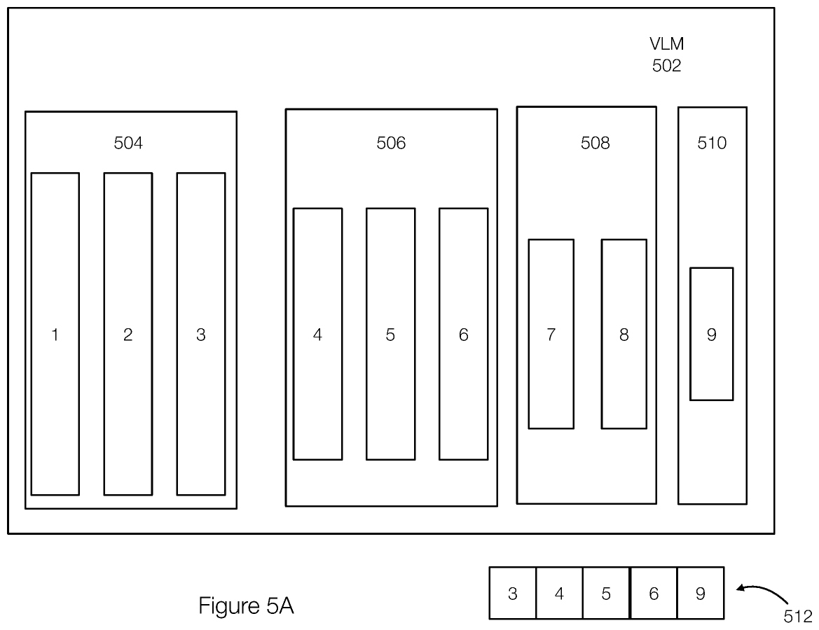

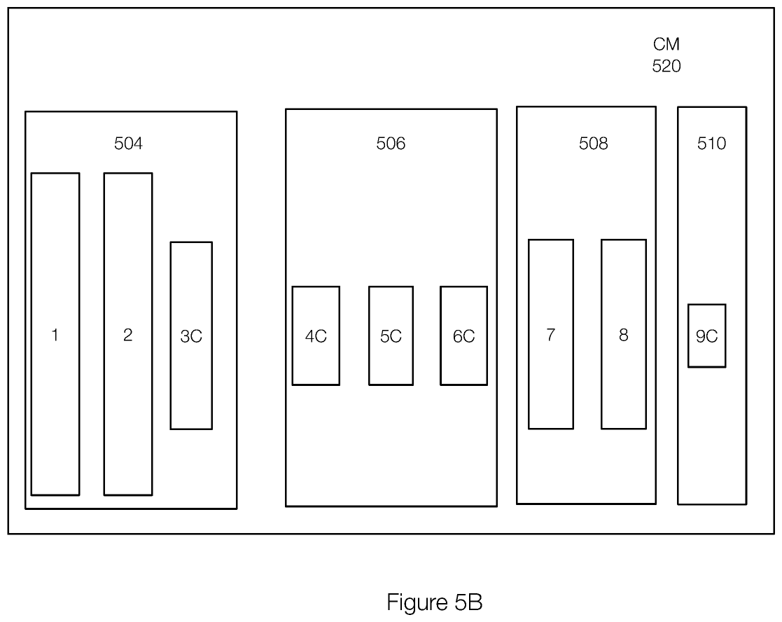

FIG. 5A discloses aspects of compressing a machine learning model. In one example, the VLM 502 is a multilayer Perceptron (MLP). The VLM 502 includes, by way of example, layers 1-9 that are also classified by type in this example. Layers 1-3 represent feature extraction 504 layers. Layers 3-6 represent abstraction 506 layers. Layers 7-8 represent disentangling 508 layers. Layer 9 represent an output 510 layer.

FIG. 5A illustrates, more generally, that classes of VLMs may include layer types. This allows the process of generating compressed models to be automated or based on a schema. For example, a rule may be generated that states, for all models of class MLP, select the following layers: last layer of feature extraction, all layers of abstraction, and first layer of output. The rule may be specified in pseudocode as follows: {‘MLP’: [[A.last, B.all, D.first], . . . ]}. This syntax denotes that a model class relates to a list of layers given by a type and a relative position in the model architecture.

Thus, rules may be defined in a pre-defined syntax to enable systematic definitions (e.g., by domain experts, external processes). The rule expresses relationships between terms (e.g., names of model classes, types of layers, positional encodings) to objects (e.g., actual layers in model instances). This type of rule also allows compressed models to be generated in an automated manner.

Applying this rule to the model 502 results in the selection 512 of layers 3, 4, 5, 6, and 9.

FIG. 5B discloses aspects of compressing a machine learning model. FIG. 5B illustrates a CM 520 in which layers 3, 5, 6, 7, and 9 are compressed and represented as compressed layers 3C, 4C, 5C, 6C, and 9C in the CM 520. FIG. 5B illustrates compressing the model 502 based on the rule {‘MLP’: [[A.last, B.all, D.first], . . . ]}.

FIGS. 4A-5B illustrate that targeted compression may be performed on selected layer(s) (e.g., a subset of the model's layers). Layers that are not selected for compression are frozen when generating the compressed model in one example such that the unselected layers are not compressed or pruned.

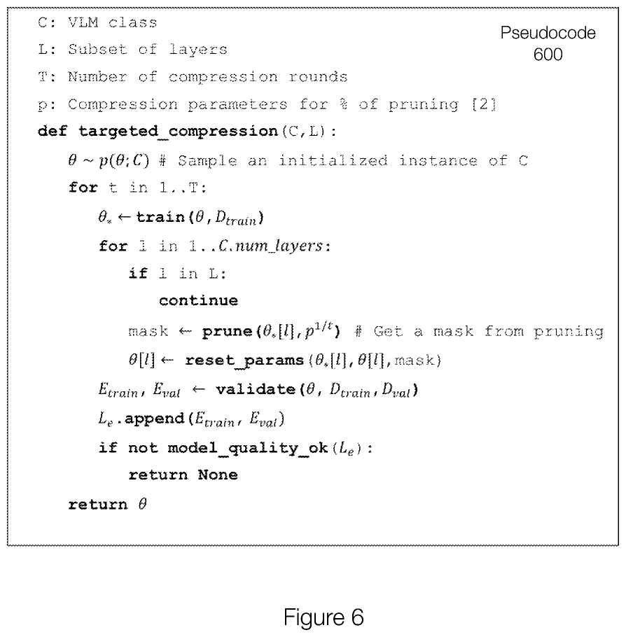

FIG. 6 discloses aspects of layer-wise compression. FIG. 6 illustrates pseudocode 600 for target compression using a Lottery Ticket scheme. The general function of the pseudocode 600 is to perform a number of training rounds, which is followed by pruning. The running may include a decay function such that less pruning is performed as the training rounds are performed. In one example, a loop may be included that ensures that the subset of layers that are not selected for compression are not compressed. These layers are skipped.

After each round of training, training and validation errors may be obtained in order to check model quality. A function for checking model quality that is able to tell if the model is going in a promising direction or if the training/validation is diverging too much from expected behavior is used. If the quality is poor or if the model is diverging too much, targeted compression may terminate. The pseudocode 600 is provided by way of example only and other training schemes are acceptable. Further, the pseudocode 600 is, more generally, an example of targeted compression that allows unselected layers to be skipped while checking for model quality to ensure that the compressed models are suitable, for example, for unit testing.

In addition to Lottery Ticket methods of pruning, compression may also be performed using quantization.

Embodiments of the invention allows layers of VLMs to be selected and compressed in a targeted fashion. The CM generated thereform can be tested, and stored. Thus, when unit testing is performed, compressed models may already be available and may be selected as needed. This allows for unit tests to be performed in a layer specific manner. For example, the impact of changes to a codebase on specific layers can be tested.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, machine learning operations, layer selection operations, rule related operations, rule-based model compression operations, selective layer model compression operations, layer specific unit testing operations, or the like. More generally, the scope of the invention embraces any operating environment in which the disclosed concepts may be useful.

New and/or modified data collected and/or generated in connection with some embodiments, may be stored in a computing environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations, services, or the like, initiated by one or more clients or other elements of the operating environment.

Example cloud computing environments, which may or may not be public, include storage environments that may provide functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, VMs, containers, or any combination of these, though no particular device implementation or configuration is required for any embodiment.

Example embodiments of the invention are applicable to any system capable of storing and handling various types of objects, in analog, digital, or other form.

It is noted that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples.

In other embodiments, the individual processes that make up a disclosed method may be performed in a sequence other than the specific sequence recited.

Following are some further example embodiments of the invention. These are presented only by way of example and are not intended to limit the scope of the invention in any way.

Embodiment 1. A method, comprising: selecting layers from a machine learning model, compressing the selected layers to generate a compressed model that corresponds to the machine learning model, generating metadata from a compressed machine learning model, comparing the metadata from the model with the metadata from the compressed machine learning model, and determining whether a behavior of the compressed machine learning model is within a threshold value of a behavior of the model based on the comparison.

Embodiment 2. The method of embodiment 1, further comprising automatically performing unit tests to test the selected layers that have been compressed in the compressed model, wherein comparing the metadata from the machine learning model and the metadata from the compressed machine learning model comprises performing the unit tests on the metadata from the machine learning model and the metadata from the compressed machine learning model.

Embodiment 3. The method of embodiment 1 and/or 2, wherein the unit tests include inner model metric unit tests, output metric unit tests, and/or evolution metric unit tests.

Embodiment 4. The method of embodiment 1, 2, and/or 3, wherein unselected layers in the machine learning model are unchanged in the compressed model.

Embodiment 5. The method of embodiment 1, 2, 3, and/or 4, further comprising determining a change in a codebase of the machine learning model, wherein the change is at least one of a data ETL (Extract-Transform-Load) change, a library update, a library rollback, a codebase change, a hardware change, a pipeline change, a dataset change or combination thereof.

Embodiment 6. The method of embodiment 1, 2, 3, 4, and/or 5, further comprising training and validating the compressed model.

Embodiment 7. The method of embodiment 1, 2, 3, 4, 5, and/or 6, further comprising selecting layers from the machine learning model based on a pre-defined rule for a class of the machine learning model and automatically generating the compressed model based on the layers selected by the rule.

Embodiment 8. The method of embodiment 1, 2, 3, 4, 5, 6, and/or 7, wherein subsequent compression operations that select layers that were previously compressed use the previously compressed layers.

Embodiment 9. The method of embodiment 1, 2, 3, 4, 5, 6, 7, and/or 8, wherein determining whether a behavior of the compressed model is within a threshold value further comprises determining whether a behavior of the model is within the threshold of a behavior of the machine learning model or is similar to the behavior of the compressed model prior to a change in a codebase.

Embodiment 10. The method of embodiment 1, 2, 3, 4, 5, 6, 7, 8, and/or 9, wherein the machine learning model is a very large machine learning model.

Embodiment 11. A system for performing any of the operations, methods or processes, or any portion of any o these, or any combination thereof disclosed herein.

Embodiment 12. A method for performing any of the operations, methods, or processes, or any portion of any of these, or any combination thereof disclosed herein.

Embodiment 13. A non-transitory storage medium having stored therein instructions that are executable by one or more hardware processors to perform operations comprising the operations of any one or more of embodiments 1-11.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the terms module, component, engine, client, agent, or the like may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

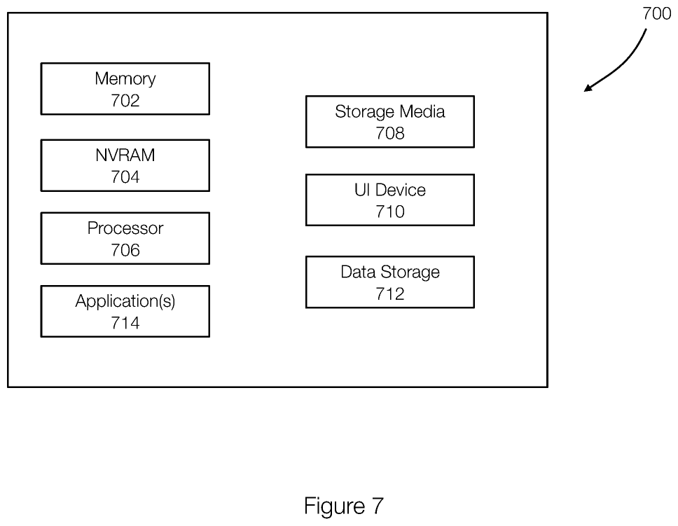

With reference briefly now to FIG. 7, any one or more of the entities disclosed, or implied, by the Figures and/or elsewhere herein, may take the form of, or include, or be implemented on, or hosted by, a physical computing device, one example of which is denoted at 700. As well, where any of the aforementioned elements comprise or consist of a virtual machine (VM), that VM may constitute a virtualization of any combination of the physical components disclosed in FIG. 7.

In the example of FIG. 7, the physical computing device 700 (or computing system) includes a memory 702 which may include one, some, or all, of random access memory (RAM), non-volatile memory (NVM) 704 such as NVRAM for example, read-only memory (ROM), and persistent memory, one or more hardware processors 706, non-transitory storage media 708, UI device 710, and data storage 712. One or more of the memory components 702 of the physical computing device 700 may take the form of solid state device (SSD) storage. As well, one or more applications 714 may be provided that comprise instructions executable by one or more hardware processors 706 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 700 may also represent computing resources of an edge system, a cloud system, cluster, or other entity.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
selecting layers from a machine learning model;
compressing the selected layers to generate a compressed model that corresponds to the machine learning model;
generating metadata from a compressed machine learning model;
comparing the metadata from the model with the metadata from the compressed machine learning model; and
determining whether a behavior of the compressed machine learning model is within a threshold value of a behavior of the model based on the comparison.

2. The method of claim 1, further comprising automatically performing unit tests to test the selected layers that have been compressed in the compressed model, wherein comparing the metadata from the machine learning model and the metadata from the compressed machine learning model comprises performing the unit tests on the metadata from the machine learning model and the metadata from the compressed machine learning model.

3. The method of claim 2, wherein the unit tests include inner model metric unit tests, output metric unit tests, and/or evolution metric unit tests.

4. The method of claim 1, wherein unselected layers in the machine learning model are unchanged in the compressed model.

5. The method of claim 4, further comprising determining a change in a codebase of the machine learning model, wherein the change is at least one of a data ETL (Extract-Transform-Load) change, a library update, a library rollback, a codebase change, a hardware change, a pipeline change, a dataset change or combination thereof.

6. The method of claim 1, further comprising training and validating the compressed model.

7. The method of claim 1, further comprising selecting layers from the machine learning model based on a pre-defined rule for a class of the machine learning model and automatically generating the compressed model based on the layers selected by the rule.

8. The method of claim 1, wherein subsequent compression operations that select layers that were previously compressed use the previously compressed layers.

9. The method of claim 1, wherein determining whether a behavior of the compressed model is within a threshold value further comprises determining whether a behavior of the model is within the threshold of a behavior of the machine learning model or is similar to the behavior of the compressed model prior to a change in a codebase.

10. The method of claim 1, wherein the machine learning model is a very large machine learning model.

11. A non-transitory storage medium having stored therein instructions that are executable by one or more hardware processors to perform operations comprising:
selecting layers from a machine learning model;
compressing the selected layers to generate a compressed model that corresponds to the machine learning model;
generating metadata from a compressed machine learning model;
comparing the metadata from the model with the metadata from the compressed machine learning model; and
determining whether a behavior of the compressed machine learning model is within a threshold value of a behavior of the model based on the comparison.

12. The non-transitory storage medium of claim 11, further comprising automatically performing unit tests to test the selected layers that have been compressed in the compressed model, wherein comparing the metadata from the machine learning model and the metadata from the compressed machine learning model comprises performing the unit tests on the metadata from the machine learning model and the metadata from the compressed machine learning model.

13. The non-transitory storage medium of claim 12, wherein the unit tests include inner model metric unit tests, output metric unit tests, and/or evolution metric unit tests.

14. The non-transitory storage medium of claim 11, wherein unselected layers in the machine learning model are unchanged in the compressed model.

15. The non-transitory storage medium of claim 14, further comprising determining a change in a codebase of the machine learning model, wherein the change is at least one of a data ETL (Extract-Transform-Load) change, a library update, a library rollback, a codebase change, a hardware change, a pipeline change, a dataset change or combination thereof.

16. The non-transitory storage medium of claim 11, further comprising training and validating the compressed model.

17. The non-transitory storage medium of claim 11, further comprising selecting layers from the machine learning model based on a pre-defined rule for a class of the machine learning model and automatically generating the compressed model based on the layers selected by the rule.

18. The non-transitory storage medium of claim 11, wherein subsequent compression operations that select layers that were previously compressed use the previously compressed layers.

19. The non-transitory storage medium of claim 11, wherein determining whether a behavior of the compressed model is within a threshold value further comprises determining whether a behavior of the model is within the threshold of a behavior of the machine learning model or is similar to the behavior of the compressed model prior to a change in a codebase.

20. The non-transitory storage medium of claim 11, wherein the machine learning model is a very large machine learning model.
